(19) United States
(12) Patent Application Publication
(10) Pub. No.: US 2004/0146646 A1
(43) Pub. Date: Jul. 29, 2004

(54) Arrangement of a metal lid and a metal housing for a measuring device and method for production thereof

(76) Inventor: Armin Wendler, Freiburg (DE)

Correspondence Address: Felix J D'Ambrosio, Jones Tullar & Cooper, Eads Station, PO Box 2266, Arlington, VA, 22202, US

(21) Appl. No.: 10/477,528

(22) PCT Filed: May 15, 2002
(86) PCT No.: PCT/EP02/05337

(30) Foreign Application Priority Data
May 21, 2001 (DE) 101 24 933.0

(51) Int. Cl. B05D 5/00

(52) U.S. Cl. 427/256

(57) ABSTRACT

The invention relates to a combination (10) of a lid (12) of a metallic material and a metallic housing (14) that can be screwed together. In order that the screwed connection (16) remain releasable even under adverse conditions, the lid (12) and/or the housing (14) is provided at at least one preselected surface portion, especially in the area of its screw thread, with a coating (18) that prevents corrosive seizure of the thread. The invention also concerns a method for manufacturing such a lid, or housing, as the case may be.

The invention relates to a combination of a lid of a metallic material and a metallic housing for a measuring instrument and to a method for manufacture of the lid and housing.

Such combinations are known especially for field measuring instruments used in process measurement and control technology for e.g. registering a physical state variable of a medium involved in the process. The registering of such variables is known per se and not the subject of this invention.

Such combinations are usually installed near the process or the medium to be measured, and are frequently exposed to unfavorable process conditions prevailing there, such as e.g. high surrounding temperatures, strong soiling, and even rain, wind, dust, snow and ice, when the installation is outside.

It has been found that the usual threaded connections of a metallic lid on a metallic housing are inclined to experience corrosive seizure. After a certain length of time, they can no longer be unscrewed, or perhaps only after considerable effort. In some cases, the only remaining solution is to break or cut the housing open.

A previous measure for preventing corrosive seizure of threaded connections is the complete coating of lid and housing. Depending on the metallic material or materials of which they are made, the coating used is nickel, a solid film lubricant, or some other powder coating, or an eloxal or hard-eloxal, anodized coating. A usual process for this uses an immersion bath containing a liquid yielding the coating. The parts to be coated are completely immersed in the liquid. Any place on the lid or housing which is not to receive coating has to be protected, either with a lacquer or by covering with an adhesive film or foil. After the immersion in the coating bath, the protection has to be removed, which requires not only an additional processing step but also additional expense for solvent.

Above and beyond this, it must be recognized that complete coating of lid and housing is extravagant, expensive and not very environmentally friendly, especially considering the long residence time that the parts to be coated must spend in the coating process.

An object of the invention, therefore, is to create a novel combination of a lid of metallic material and a metallic housing that screw together for containing a measuring instrument, where, even under difficult conditions, the screw connection remains releasable. Additionally, this lid-housing combination must be simple to create, of reasonable cost, and friendly to the environment, while avoiding the above-described disadvantages of the prior art.

This object is attained by a first variant of a combination according to the invention of a lid of a metallic material and a metallic housing for a measuring instrument, wherein the lid and the housing are provided with a screw thread so that the lid can be screwed into, or onto, the housing, as the case may be, and the lid is provided only on at least one preselected surface portion, especially in the area of its screw thread, with a coating that prevents corrosive seizure of its screw thread.

This object is also attained by a second variant of a combination according to the invention of a lid of a metallic material and a metallic housing for a measuring instrument, wherein the lid and the housing are provided with a screw thread so that the lid can be screwed into, or onto, the housing, as the case may be, and wherein the housing is provided only on at least one preselected surface portion, especially in the area of its screw thread, with a coating of a type which prevents corrosive seizure of its screw thread.

In further embodiments of the combination of the invention, the coating is electrically insulating.

Other embodiments of the invention concern a coating formed of an eloxal layer.

Still other embodiments of the combination of the invention concern an electrical connection between lid and housing.

In yet another embodiment of the invention, the coating is omitted in the zone where electrical contact is desired between lid and housing.

A further embodiment of the invention concerns a coating that is provided solely in the area of the screw thread.

An additional embodiment of the invention is a method for producing a coating for a combination of the invention, wherein a medium, which serves for creating the coating, acts solely on the area that is to be coated.

In a further embodiment of the method of the invention, the medium, which serves for creating the coating, acts only on the screw thread.

The special advantages achievable with the invention are to be seen in that, in the combination presented here, a coating is only applied where it is really necessary. This saves energy and coating material, because no excess coating is applied. The residence times for the parts to be coated in the coating process are shortened: Subsequent removal of protective coverings from the locations where no coating is desired per se, is no longer required. Since the parts to be coated must no longer be immersed completely in an immersion bath, the method and the lid, or housing, as the case may be, coated with the method, are of reasonable cost, fast, and environmentally friendly. It is even possible to coat pre-assembled parts, since the coating is only done where it is really desired. Parts, which are not to be coated, are not affected, and the coating process is not affected either.

The invention is described and explained below on the basis of examples of embodiments and with the help of drawings, which show as follows:

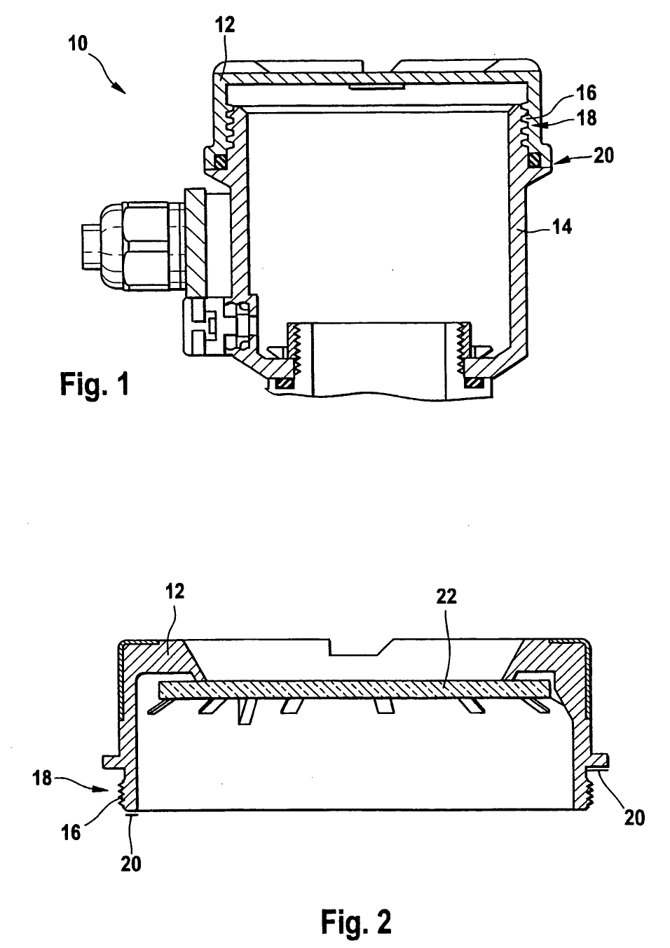

FIG. 1: a schematic, cross sectional presentation of a first embodiment of a measuring instrument housing with lid screwed on;

FIG. 2: a schematic, cross sectional presentation of a lid of another embodiment of the invention; and

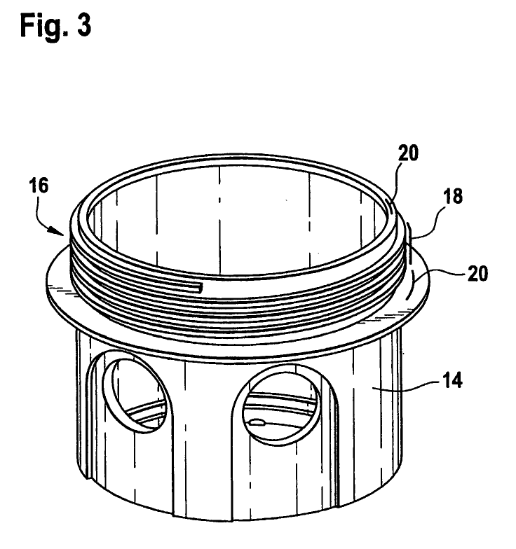

FIG. 3: A schematic, cross sectional presentation of a housing of another embodiment of the invention.

FIG. 1 shows a first embodiment of a combination 10 of the invention. The drawing illustrates a lid 12 screwed together with a housing 14. Lid 12 and housing 14 each has a matching screw thread 16 for this purpose. Lid 12 and housing 14 are made of a metallic material, but it is not required that they both be made of the same material. Preferably, however, lid 12 is made of aluminum.

In the area of the screw threads 16, either the lid 12 or the housing 14 is provided with a coating 18, preferably an eloxal coating, which prevents corrosive seizure of the threads 16. For other applications and/or other materials for the lid 12, or housing 14, as the case may be, other coatings resisting corrosive seizure are conceivable. Likewise, without limiting the invention, it is possible to coat both the lid 12 and the housing 14 in the area of their threads 16.

The coating is done not in an immersion bath with a suitable coating liquid, into which the lid 12, or the housing 14, as the case may be, is completely immersed, but, rather, it is done quasi pointwise, in that the coating liquid is only applied to the locations on the lid 12 and/or housing 14 where the coating is desired. Other locations or surface portions of the lid 12 or housing 14 than those to be coated are not contacted or affected by the coating liquid.

FIG. 2 illustrates in an enlarged, schematic, cross sectional drawing another example of an embodiment of a metallic lid 12 for a combination of the invention. In the case of this lid 12, the thread 16 is embodied as an external thread on that part of the lid 12 that is to be screwed into an opening of a housing provided with a matching internal thread. Since the lid 12 illustrated here is to have an electrically conducting connection with the metallic housing, the coating 18, which is only applied in the area of the thread 16, has been omitted from the areas 20 on ends or shoulders of the lid 12 where the electrical connection is to be made. A transparent plate or disk 22 provided in the lid 12 illustrated in FIG. 2 can already be mounted in place, before the actual coating of the lid 12, and is not affected by the coating. In this case, also, the coating is limited to the area of the thread 16.

The metallic housing 14 presented by itself in FIG. 2 illustrates again a region with thread 16 which is the only region or surface portion on the housing 12 that is coated with the coating against corrosive seizure. Similarly to the case for the lid 12 illustrated in FIG. 2, this housing 14, which is actually intended for another lid, is likewise designed for an electrical contact between lid and the housing 14. Indeed, this contact will occur in the areas 20, thus on shoulders of the housing 14 that will be in direct mechanical contact with a lid screwed onto the housing 14. In order not to interfere with the direct physical, and the desired electrical, contact, the coating is omitted in these zones 20.

1. Combination of a lid (12) of a metallic material and a metallic housing (14) for a measuring instrument, wherein the lid (12) and the housing (14) are provided with a screw thread (16), and the lid (12) is provided only on at least one preselected surface portion, especially in the area of its screw thread (16), with a coating (18) that prevents corrosive seizure of its screw thread (16).

2. Combination of a lid (12) of a metallic material and a metallic housing (14) for a measuring instrument, wherein the lid (12) and the housing (14) are provided with a screw thread (16), and wherein the housing (14) is provided only on at least one preselected surface portion, especially in the area of its screw thread (16), with a coating (18) which prevents corrosive seizure of its screw thread (16).

3. Combination as claimed in claim 1 or 2, wherein the coating (18) is electrically insulating.

4. Combination as claimed in claim 3, wherein the coating (18) is an eloxal layer.

5. Combination as claimed in one of the preceding claims, wherein an electrical connection is produced between lid (12) and housing (14).

6. Combination as claimed in claim 5, wherein the coating is omitted in a zone (20) where the electrical contact is desired between lid (12) and housing (14).

7. Combination as claimed in one of the preceding claims, wherein the coating (18) is provided solely in the area of the screw thread (16).

8. Method for producing a coating (18) for a combination as claimed in one of the claims 1 to 7, wherein a medium, which serves for creating the coating, acts solely on the area that is to be coated.

9. Method as claimed in claim 8, wherein the medium, which serves for creating the coating, acts only on the screw thread (16).
